(19) United States
(12) Patent Application Publication
(10) Pub. No.: US 2017/0235701 A1
(43) Pub. Date: Aug. 17, 2017

(54) SERIAL SIDEBAND SIGNALING LINK

(71) Applicant: INTEL CORPORATION, Santa Clara, CA (US)

(72) Inventors: Akshay Pethe, Hillsboro, OR (US); Mahesh Wagh, Portland, OR (US); David Harriman, Portland, OR (US); Su Wei Lim, Penang (MY); Debendra Das Sharma, Saratoga, CA (US); Daniel Froelich, Portland, OR (US); Venkatraman Iyer, Austin, TX (US); James Jaussi, Hillsboro, OR (US); Zuoguo Wu, San Jose, CA (US)

(73) Assignee: INTEL CORPORATION, Santa Clara, CA (US)

(21) Appl. No.: 15/503,097

(22) PCT Filed: Dec. 24, 2014
(86) PCT No.: PCT/US2014/072389

§ 371 Date: Feb. 10, 2017

(30) Foreign Application Priority Data
Sep. 11, 2014 (MY) PI 2014702585

(51) Int. Cl. G06F 13/42; G06F 13/38

(52) U.S. Cl. CPC G06F 13/4286; G06F 13/385; G06F 2213/0042; G06F 2213/4002

(57) ABSTRACT

Techniques for embedded high speed serial interface methods are described herein. The techniques include an apparatus for sideband signaling including a first serial sideband link module and a second serial sideband link module. The first serial sideband link module is to propagate packets from an upstream port to a downstream port via a first signaling lane, and the second serial sideband link module is to propagate packets from the downstream port to the upstream port via a second signaling lane.

### TECHNICAL FIELD

This disclosure relates generally to sideband signaling. Specifically, this disclosure relates to a serial sideband signaling link.

### BACKGROUND

In today's computing industry, signaling link technologies may have a main signaling link and be associated with sideband signals that are not configured to propagate over the main signaling link. Sideband link input/output (I/O) technologies provide a way for a sideband signal to be provided from one component within a computing device to another component without being propagated on the main signaling link. For example, in Peripheral Component Interconnect Express (PCIe) main signaling link technology, sideband signals may be propagated through a number of different sideband I/OP technologies such as a Card Electromechanical (CEM) sideband link, a mini CEM, a System Management Bus (SMBus), and the like. However, many times motherboard manufacturers may desire to modify existing sideband technologies by using glue logic. Glue logic, as referred to herein, is one or more custom logic modifications made to a sideband signaling link. In some cases, glue logic is difficult to implement with existing sideband I/O technologies as design and operation of these technologies may be sophisticated in comparison to the glue logic.

### BRIEF DESCRIPTION OF THE DRAWINGS

FIG. 1 illustrates a block diagram of serial sideband links between an upstream port and a downstream port;

FIG. 2 illustrates a number of scenarios where a serial sideband link consolidates sideband signals;

FIG. 3 is a diagram illustrating timing of an asynchronous handshake;

FIG. 4 is a diagram illustrating various packet formats of the serial sideband link;

FIG. 5 is a diagram illustrating a profile negotiation packet;

FIG. 6 is a diagram illustrating an example packet format for a CEM profile;

FIG. 7A and FIG. 7B are diagrams illustrating profile negotiation on the serial sideband link;

FIG. 8 is a diagram illustrating a serial bit stream of the serial sideband link;

FIG. 9 is a diagram illustrating a packet exchange on the serial sideband link;

FIG. 10 is a diagram illustrating a sample implementation of a serial sideband link module;

FIG. 11 is a diagram illustrating pulse width modulation (PWM) encoding used in the serial sideband link;

FIG. 12 is a diagram illustrating a cascaded switch hierarchy implemented with serial sideband links;

FIG. 13 is diagram illustrating a retimer within a serial sideband link that is configurable by the serial sideband link;

FIG. 14 is a diagram illustrating transitions of a Link Training and Status State Machine (LTSSM) indicated on the serial sideband link;

FIG. 15 is diagram illustrating a retimer within a serial sideband link that is configurable by the serial sideband link;

FIG. 16 are diagrams illustrating various ways in which the serial sideband signaling may be arranged in a daisy chain fashion; and

FIG. 17 is a block diagram illustrating a method of serial sideband link signaling.

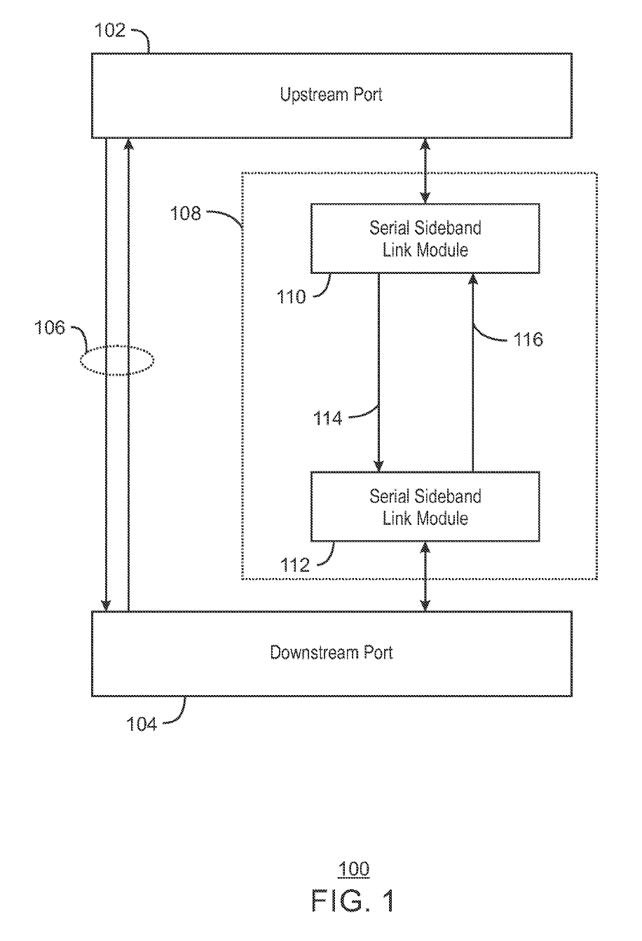

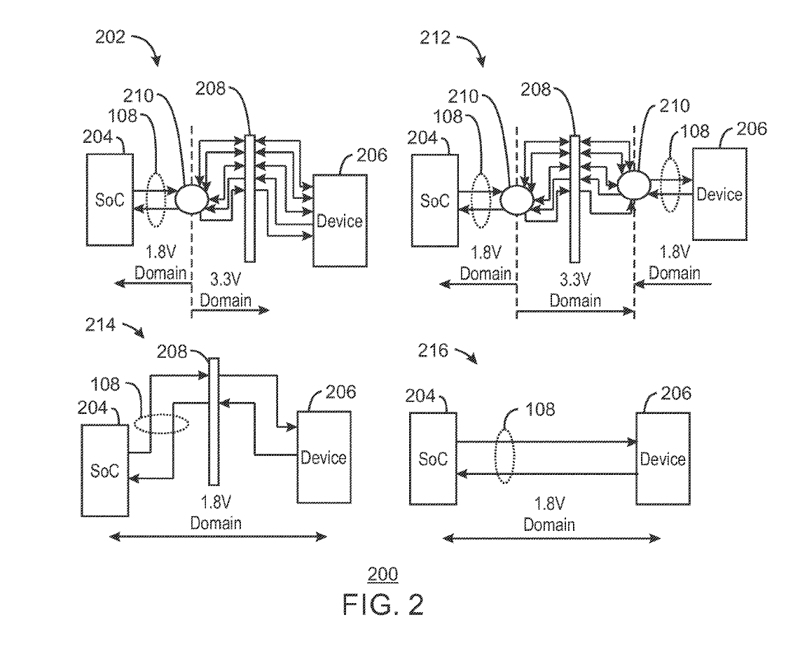

In some cases, the same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

The techniques described herein include a serial sideband link. The serial sideband link includes a first serial sideband link module configured to propagate signals in one direction, and a second serial sideband link module configured to propagate signals in another direction. In embodiments, the serial sideband link may be used to consolidate other sideband link I/O technologies, such as CEM, Mini CEM, and the like, into a single serial sideband link, thereby potentially reducing pin count on any given connected components. The serial sideband link may also enable a scalable number of sideband signals to be added without adding pin count.

FIG. 1 illustrates a block diagram of serial sideband links between an upstream port and a downstream port. An upstream port 102 may be communicatively coupled to a downstream port 104 via a main signaling link 106. Sideband signals may be propagated over a serial sideband signaling link 108. As illustrated in FIG. 1, sideband signals may be propagated in one direction by a first serial sideband link module 110, and in an opposite direction by a second serial sideband link module 112.

For example, the main signaling link 106 may be a PCIe fabric, and sideband signals are propagated on the serial sideband signaling link 108. In embodiments, the downstream port 104 is a controller, such as a system on chip (SoC), and the upstream port 102 may be a device, such as an expansion card communicatively coupled to a SoC.

In any case, the first serial sideband link module 110 is to propagate signals from the upstream port 102 to the downstream port 104 on a first signaling lane 114. The second serial sideband link module 112 is to propagate signals from the downstream port 104 to the upstream port 102 via a second signaling lane 116.

FIG. 2 illustrates a number of scenarios where a serial sideband link consolidates sideband signals. At 202, a SoC 204 is communicatively coupled to a device 206 through the serial sideband link 108. However, rather than being directly connected, the device 206 may be connected to one or more sideband link I/O technologies via a connector 208. The connector 208 may be a connecter associated with sideband link technologies such as CEM, mini CEM, SMBus, and the like. In other words, the serial sideband link 108 is backwards compatible to other legacy sideband technologies, as well as any further sideband technologies. As indicated by the dashed line, the serial sideband link 108 may convert voltages to a 1.8 volt (V) domain that is compatible with the SoC 204 at glue logic 210. At 212, glue logic 210 may be disposed on either side of the connector 208, and the serial sideband link 108 may be used on either side of the glue logic 210.

In some cases, glue logic may not be used to connect the connector to the serial sideband link 108, as indicated at 214. In this scenario, the serial sideband link 108 may directly interface with the connector 208. In yet other cases, the serial sideband link 108 may communicatively couple the SoC 204 to the device 206 via integrated components of the serial sideband link 108 within the SoC 204 and the device 206, as indicated at 216.

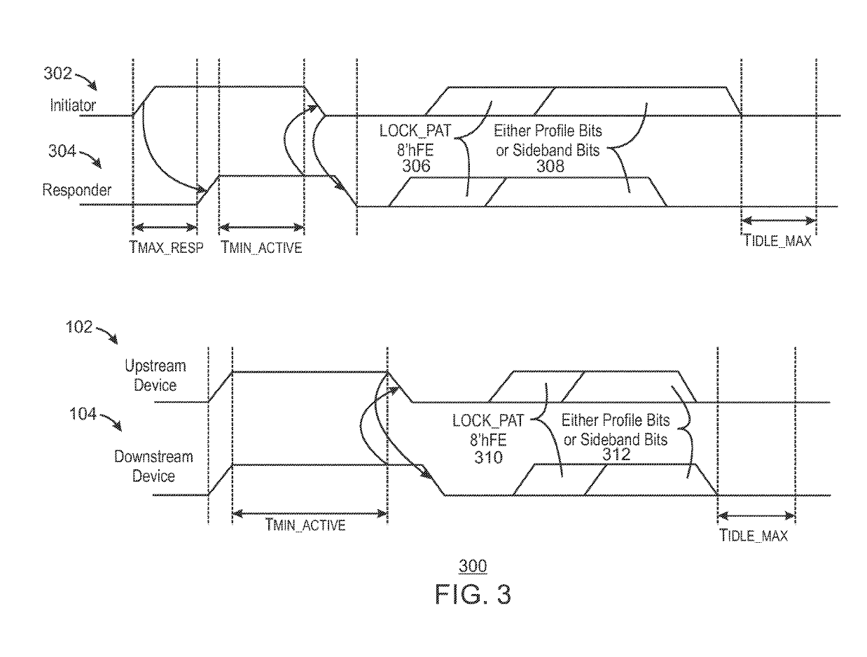

FIG. 3 is a diagram illustrating timing of an asynchronous handshake. The serial sideband link 108 may be in an idle state, and either side can be clock and/or power gated. An asynchronous handshake performed on either side of the link may be used to wake up a remote side. If either side is clock and/or power gated, this asynchronous handshake should be used to start the phase locked loops (PLLs) and establish stable power and clocks in order to correctly receive a serial bit stream on the serial sideband link 108.

As illustrated in FIG. 3, the side that initiates the asynchronous handshake may be referred to herein as an initiator, indicated at 302, and the side that receives the asynchronous handshake may be referred to herein as a responder, indicated at 304. The initiator 302 and the responder 304 may be either upstream ports, or downstream ports, such as the ports 102 and 104 discussed above in regard to FIG. 1.

The initiator 302 initiates the asynchronous handshake by asserting a sideband signal of a predetermined high voltage. The responder 304 acknowledges the start of the asynchronous handshake by asserting a sideband signal of the predetermined high voltage. The initiator 302 keeps the signal asserted for a first time period, indicated by T_{MIN}_{_}_{ACTIVE} in FIG. 3. Both the initiator 302 and the responder 304 are configured to de-assert their sideband signals any time after T_{MIN}_{_}_{ACTIVE}. It is assumed that either side de-asserts their respective predetermined high voltage only when all required clocks are active and stable.

A byte value is transmitted using pulse width modulation (PWM) encoding to help the responder 304 recover a clock, as indicated at 306. In embodiments, the byte value is an 8 bit value, wherein the first seven bits are of a value of 1 and the last bit is of a value of 0. This simple value may enable relatively quick clock recovery. A profile negotiation, and/or a serial sideband signal packet may follow, as indicated at 308. If the serial sideband link is idle for a second time period, indicated by T_{MAX}_{_}_{IDLE} in FIG. 3 and a sideband packet has to be transmitted, then the asynchronous handshake is repeated.

In some scenarios, both sides may initiate a handshake simultaneously. In this case, an upstream port, such as the upstream port 102 of FIG. 1, and a downstream port, such as the downstream port 104 of FIG. 1, initiate the handshake by asserting the predetermined high voltage on the serial sideband link associated with each port, respectively. Both ports 102 and 104 keep the signal asserted for T_{MIN}_{_}_{ACTIVE}. Both the downstream port 104 and the upstream port 102 are configured to de-assert their sideband signals any time after T_{MIN}_{_}_{ACTIVE}. It is assumed that either side de-asserts only when all the clocks of the respective port are active and stable in either separate reference clock or common clock configurations.

A byte value is transmitted using PWM encoding to help either side recover a clock, as indicated at 310. In embodiments, the byte value is an 8 bit value, wherein the first seven bits are of a value of 1 and the last bit is of a value of 0. A profile negotiation, and/or a serial sideband signal packet may follow, as indicated at 312. If the serial sideband link is idle for a second time period, indicated by T_{MAX}_{_}_{IDLE} in FIG. 3 and a sideband packet is to be transmitted, then the asynchronous handshake is repeated.

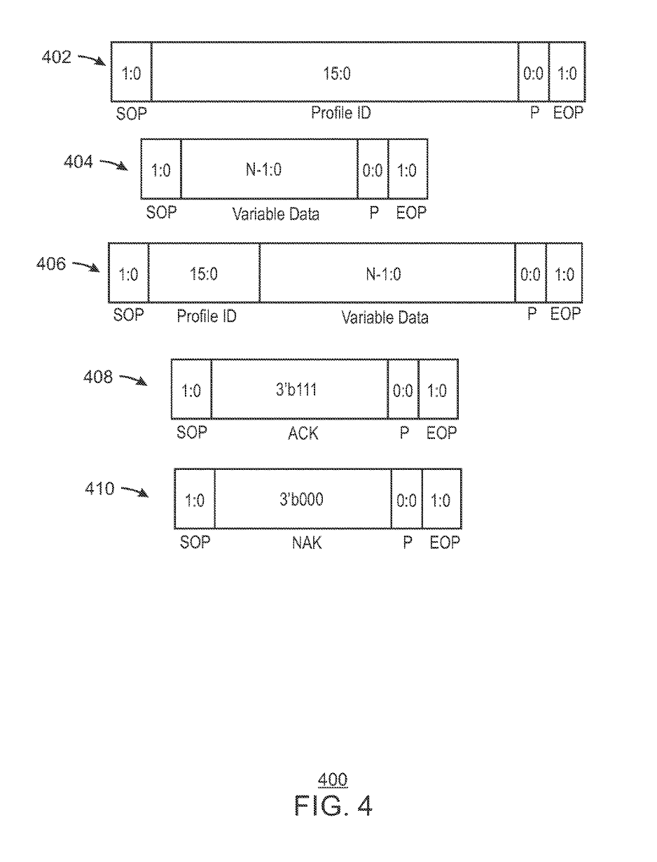

FIG. 4 is a diagram illustrating various packet formats of the serial sideband link. The various packet formats include a profile negotiation 402, sideband signals for a fixed profile 404, sideband signals for a dynamic profile 406, an acknowledgement (ACK) packet 408, a non-acknowledgement (NAK) packet 410, and the like. The packet format fields may be indicated in Table 1 below:

TABLE 1

| Field Name | Description |
|---|---|
| SOP | Start of Packet (2′b10) |
| PROFILE ID | 16 bit profile register indication support |
| | for or the selected profile |
| P | Odd parity bit for the entire packet |
| | excluding SOP and EOP |
| EOP | End of Packet (2′b01) |

In some scenarios, the asynchronous handshake, as discussed above, may be used during power on reset, hot plug events, and the like. A hot plug event may also include a hot unplug event. Hot plug and hot unplug events include adding or removing components, such as an upstream port 102 of an expansion card, from connection with a downstream port 104 without prior indication. In these scenarios, an asynchronous handshake may be performed, and a profile negotiation may follow, as discussed in more detail below. If either side does not support certain bits in a given profile, they are to be ignored by the receiving side.

The serial sideband link 108 may be configured to perform a profile negotiation every time there is a hot plug event, state changes, or any combination thereof. In these circumstances, a profile negotiation is performed following the very first asynchronous handshake after these events.

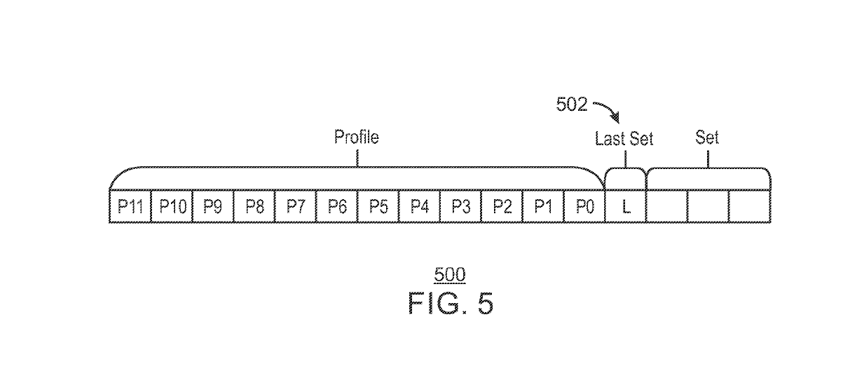

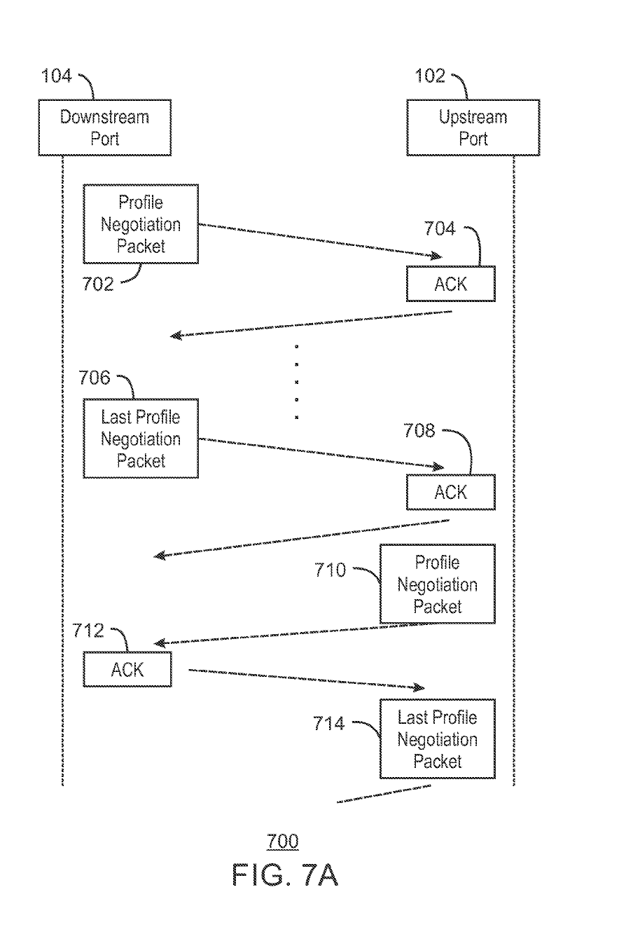

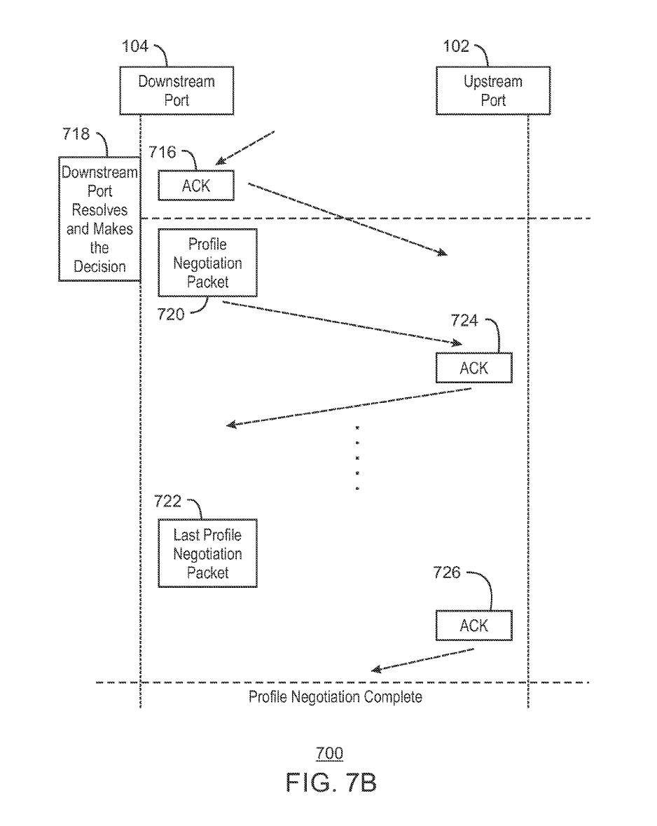

FIG. 5 is a diagram illustrating a profile negotiation packet. Each end of the serial sideband link, such as the serial sideband link 108 of FIG. 1, is configured to maintain a 16 bit register indicating support for various profiles that may be supported by each end. Profiles are used to enable operation across various use cases such as different form factors, I/O technologies, SoC designs, and the like. Each profile defines a certain set of sideband signals. The one or more profiles to be used during serial sideband link operation may be negotiated only once during initialization out of reset. The profile negotiation is discussed below in regard to FIG. 7A and FIG. 7B.

As illustrated in FIG. 5, the profile negotiation packet may also include an “L” value indicating whether a port is transmitting a last profile of a plurality of profiles supported, indicated at 502. An example of the fields in the register is indicated in Table 2 below:

TABLE 2

| Profile ID | Description |
|---|---|
| S0-P0 | CEM |
| S0-P1 | Mini CEM |
| S0-P2 | M.2 |
| S0-P3 | SFF |
| S0-P4 | Retimer |
| S0-P5 to S0-P15 | Reserved |
| S1-Px to S7-Px | |

As illustrated in Table 2, existing sideband link I/O technologies may be identified in the profile register of the serial sideband link 108. In embodiments, the identification is performed by logic of the one or more of the serial sideband link modules 110 and 112, discussed above with regard to FIG. 1. As further illustrated in Table 2, the serial sideband link techniques discussed herein may be scalable to add additional sideband link I/O technologies in profile ID fields 6-15.

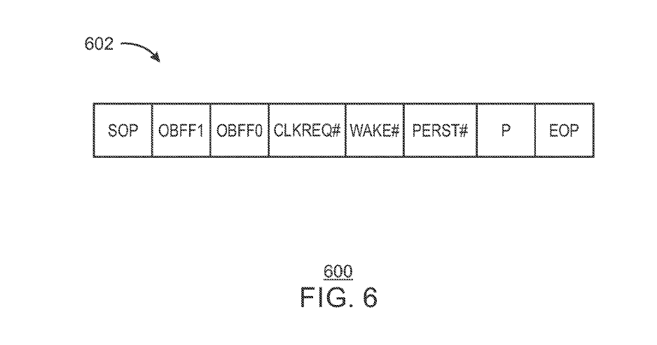

FIG. 6 is a diagram illustrating an example packet format for a CEM profile. As discussed above in regard to FIG. 5, existing sideband link I/O technologies may be identified by the serial sideband link 108. For example, the serial sideband link 108 of FIG. 1 may identify CEM as an existing sideband link technology communicatively coupled to the serial sideband link 108. The CEM may use Optimized Buffer Flush/Fill (OBFF) toggle mechanisms of a single pin. The serial sideband link 108 may, via a serial sideband link module 110, 112, encode any signals from the CEM such that CEM information is sent as a 2 bit code across the serial sideband link 108.

A packet format 602 of the serial sideband link 108 is illustrated in FIG. 6. The CEM profile details may be illustrated by Table 3 below:

TABLE 3

| Serial Bits | D2U_P0 | U2D_P0 | Description |
|---|---|---|---|
| b0 | OBFF bit 1 | — | 4 OBFF messages |
| b1 | OBFF bit 0 | — | encoded in a binary |
| | | | code |
| b2 | CLKREQ# | CLKREQ# | Clock request |
| b3 | | WAKE# | Wake signal |
| b4 | PERST# | — | Fundamental Reset |

As illustrated in Table 3, OBFF messages have been encoded as a 2 bit code instead of relying on rising and falling edges. Different values in the profile bits may lead to different number of bits causing different sideband signals to be propagated on the serial sideband link 108.

FIG. 7A and FIG. 7B are diagrams illustrating profile negotiation on the serial sideband link. As discussed above, after the asynchronous handshake, a profile negotiation may occur. The profile negotiation determines the one or more profiles available at each port, such as the upstream port 102 and the downstream port 104 of FIG. 1. The profile determination defines the sideband signals in the packets that are exchanged. The profile negotiation takes place immediately following a byte value, such as the byte value 306, propagated as discussed above in regard to FIG. 3.

As illustrated in FIG. 7A, a downstream port, such as the downstream port 104 of FIG. 1, sends a profile negotiation packet with a value of 1 set in all the profiles that it supports, as indicated at 702. The packet is received at an upstream port, such as the upstream port 102 of FIG. 1. The upstream port 102 transmits an acknowledgement (ACK) packet, as indicated at 704, upon successfully receiving a profile negotiation packet.

In some embodiments, the downstream port 104 may be configured to refrain from transmitting another profile negotiation packet until it receives an ACK packet for the last profile negotiation packet it has transmitted at 702. If the downstream port 104 receives a non-acknowledgement (NAK) packet, or after two milliseconds, the same profile negotiation packet will be retransmitted.

In some cases, the downstream port 104 is configured to transmit a value of 0 in an “L” field, such the L field indicated in FIG. 5. The downstream port 104 is configured to transmit the value of 1 in the L field if there are more sets to be transmitted. The downstream port 104 sets a value of 1 in field L field it is transmitting a final profile of a plurality of profiles supported by the downstream port 104, as indicated at 706.

After receiving the final profile of the plurality of profiles from the downstream port 104, the upstream port may be configured to transit an ACK packet as indicated at 708. The upstream port 102 may be further configured to transmit a profile negotiation packet, as indicated at 710, indicating one or more profiles supported by the upstream port 102. At 712, the downstream port 104 may be configured to send an ACK packet. Similar to the downstream port 104, the upstream port may be configured to send a plurality of profile negotiation packets, wherein a value of 1 will indicate a last profile in supported by the upstream port 102, as indicated at 714.

The profile negotiation continues at FIG. 7B, wherein at 716, the downstream port 104 may be configured to send an ACK packet, upon receiving the last profile supported by the upstream port 102. The downstream port 104 may be configured to determine which profile, or profiles, to use for transmission, as indicated at 718. The downstream port 104 may transmit a profile negotiation packet at 720, or a plurality of profile negotiation packets until a last profile negotiation packet at 722, with a value of 1 set only in those profiles which are to be used for the serial sideband link operation, whereupon the upstream port 102 is configured to transmit an ACK packet back to the downstream port, as indicated at 724 in the case of a single profile packet, or at 726 in the case of multiple profile packets transmitted from the downstream port 104.

Referring back to FIG. 5, the profile support package may be illustrated in Table 4 below:

TABLE 4

| Field | Description |
|---|---|
| b0-b2 | Set: |
| | This 3 bit field defines 8 sets. Each set |
| | may have up to 12 profiles |
| | S0 - Active |
| | S1-S7 - Reserved |
| b3 | Last Set: |
| | This bit is used during profile |
| | negotiation. This bit does not have any |
| | meaning during any other part of the |
| | link operation. |
| | If set this bit indicates that the current |
| | set being sent is the last set. |
| b4-b15 | Profile: |
| | This 12 bit register is used to indicate |
| | support for 12 different profiles. A value |
| | of 1 in any bit indicates support for that |
| | particular profile. More than 1 bit may |
| | be set to indicate support for multiple |
| | profiles. |
| | For e.g.: |
| | b4 - indicates support for profile P0 |

As illustrated in Table 4, a set of profiles may be identified in the 3 bit field defining 8 sets, and wherein each set may have up to 12 profiles.

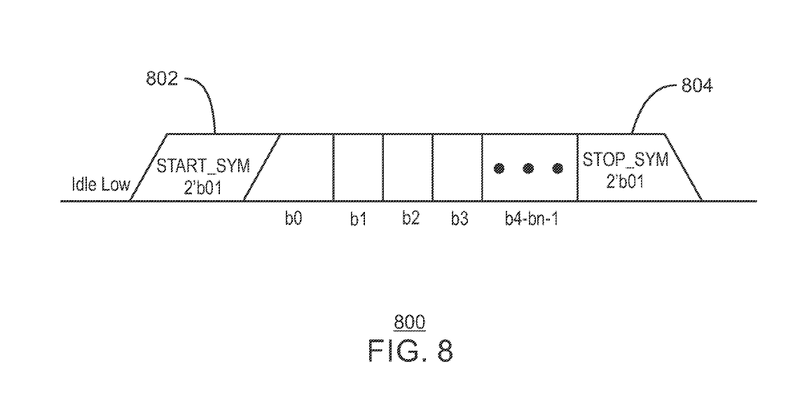

FIG. 8 is a diagram illustrating a serial bit stream of the serial sideband link. A serial sideband link, such as the serial sideband link 108 of FIG. 1, does not send a separate clock signal on the serial sideband link 108. This simplifies the signaling and enables for consolidation of sideband signaling technologies. Instead, PWM encoding is used to help with clock recovery and correct decoding of the bits. PWM encoding and PWM decoding require small hardware resources and may be more robust than signaling technologies requiring a forwarded clock, such as Non-Return to Zero (NRZ) encoding.

The serial sideband link 108 is idle when no signals are being sent. A start symbol, or start of packet (SOP), is sent to start the transmission followed by sideband signals having high latency sensitivity in comparison to other sideband signals. Based on the profile selected, some of the bits will have a predefined meaning. For example, the SOP may have a value of 2′b01, indicated at 802. The bits b 0 to bn 01 are then configured to have a predefined meaning. The packet may then end with a stop symbol with a value of 2′b10, as indicated at 804.

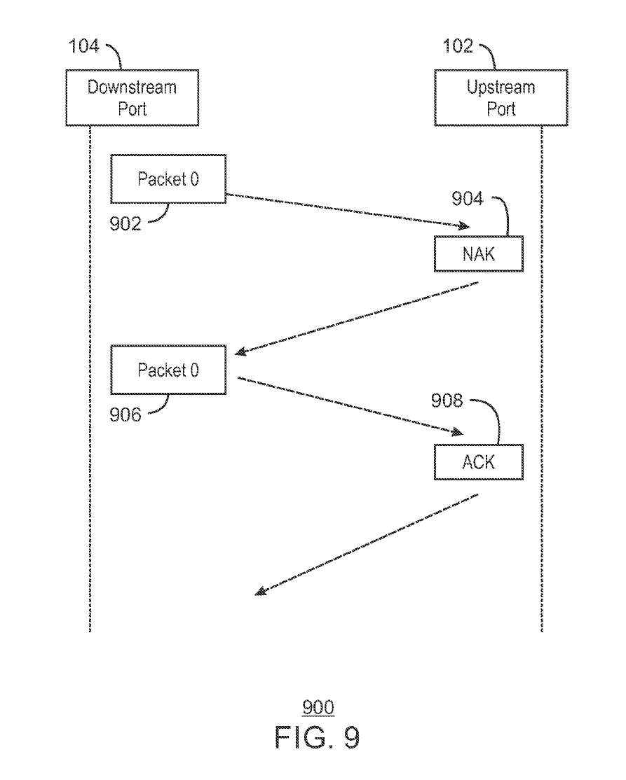

FIG. 9 is a diagram illustrating a packet exchange on the serial sideband link. In embodiments, to keep the serial sideband signals simple, yet reliable, a one bit parity bit included in each packet. This bit maintains an odd or even parity for the entire packet excluding the SOP and end of packet (EOP) fields. For example, if the parity bit is set to an odd parity, then if a receiving end receives a packet with a parity bit that is odd, the receiving end will send an acknowledgement (ACK) packet. If the receiving end received a parity bit that is even, the receiving end will receive a non-acknowledgement (NAK) packet back to the transmitting end. Upon receiving a NAK, the transmitting end will send a new packet with the latest value of serial sideband signals.

For example, a transmitting end may be a downstream port, such as the downstream port 104 of FIG. 1, and the receiving end may be an upstream port, such as the upstream port of FIG. 1. The downstream port 104 may send a packet 0 to the upstream port 102, as indicated at 902. If the parity value does not match a predetermined parity between the two ports, the upstream port will return a NAK packet, as indicated at 904. At 906, the downstream port 104 will send a new packet with the latest value of serial sideband signals to the upstream port 102. Upon determining a correct parity value, the upstream port 104 will send and ACK packet back to the downstream port 104.

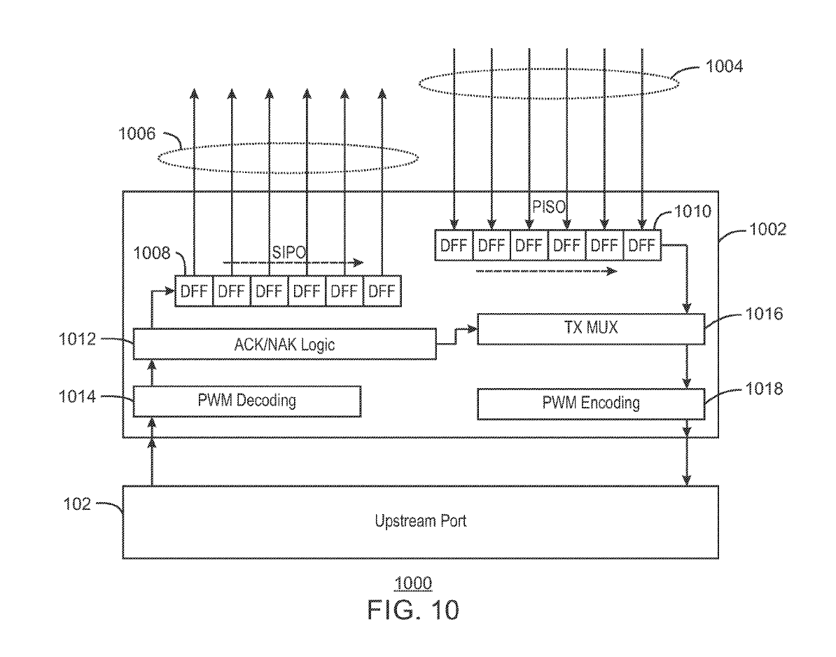

FIG. 10 is a diagram illustrating a sample implementation of a serial sideband link module. A serial sideband link module 1002 is configured to receive signals from an existing connector (now shown), as indicated at 1004, and transmit signals to the existing connector, as indicated at 1006. In this example illustration, the serial sideband link module 1002 is implemented having a Serial In Parallel Out (SIPO) architecture. The blocks 1008 and 1010 are electrical flops, or a latches, having two stable states. Block 1012 may include combinatorial logic, at least partially comprising hardware logic, configured to implement the ACK and NAK signaling discussed above in regard to FIG. 9.

As illustrated in FIG. 10, the serial sideband link module 1002 may have additional submodules including a PWM decoding module 1014, a transmission (TX) multiplexing (MUX) module 1016, and a PWM encoding module 1018. Each of the PWM decoding module 1014, the TX MUX module 1016, and the PWM decoding module 1018, may be implemented as a mix of both combinatorial logic and electrical flops or latches.

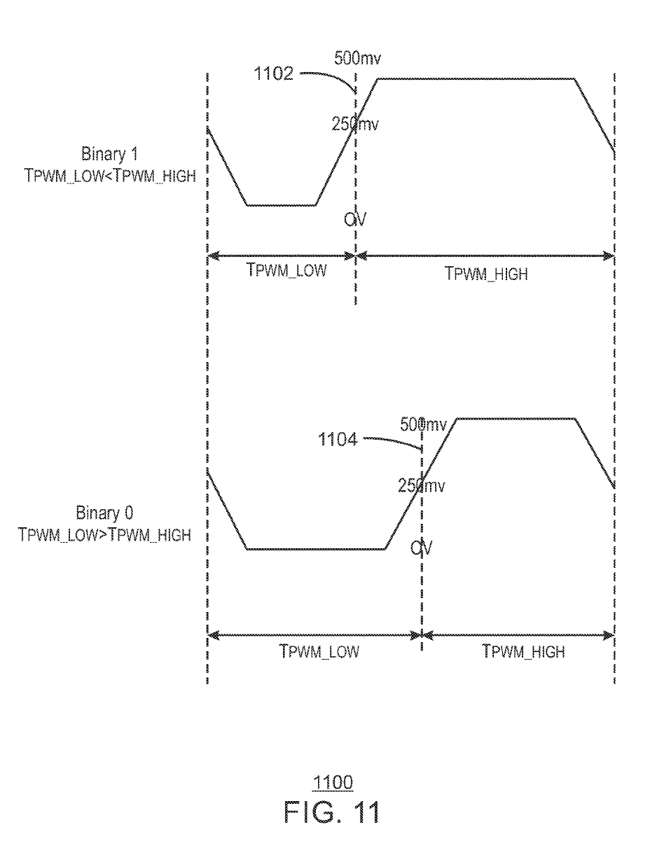

FIG. 11 is a diagram illustrating pulse width modulation (PWM) encoding used in the serial sideband link. As discussed in many references above, the techniques described herein include the use of PWM encoding to convey 1 bit using two logic levels. Depending on a ratio of widths of either logic level, a unit interval is decoded as either a 1 or a 0.

For example, each bit consists of two periods: a negative voltage period followed by a positive voltage period as illustrated in FIG. 11. A rising edge can either be at one-third of an interval, as indicated at the dashed line 1102, or at two-thirds of an interval, as indicated at the dashed line 1104. If the rising edge is at the one-third interval 1102, the bit period is encoded as a binary 1. If the rising edge is at the two-thirds interval 1104, then the bit period is encoded as a binary 0.

It may be important to note that PWM encoding described herein includes self-clocking properties. The rise time and fall time are defined as the time it takes for the signal to transition between about 20% and 80% signal levels of a differential output signal. Electrical parameters for PWM may be illustrated in Table 5 below:

TABLE 5

| | | | |
|---|---|---|---|
| Symbol | Min | Max | Description |

Voltage (mV)

| | | | |
|---|---|---|---|
| VFS_DC | 1200 | 1800 | Full Swing TX DC voltage with |
| | | | unterminated TX. |

Resistance (Ω)

| | | | |
|---|---|---|---|
| R | 40 | 60 | Single ended output resistance. |

Bit Duration (us)

| | | | |
|---|---|---|---|
| TPWM_BIT | 1/36 | 1/12 | PWM transmit bit duration |

In some cases, the serial sideband link described above is configured to operate at 19.2 MegaTransfers per second (MT/s). In this scenario, one unit interval will be 52 nanoseconds (ns). If the encode/decode logic is running a 100 Megahertz (MHz) clock, 1 clock cycle will be about 10 ns. Assuming one flop stage on the transmit side as well as the receive side, a total latency for encoding, transmitting, and decoding 1 bit may be about T_{LAT}_{_}_{BIT} defined in Equation 1 below:

T_{LAT}_{_}_{BIT}=52 s+20 ns+propagation delay=72 ns+propagation delay Eq. 1

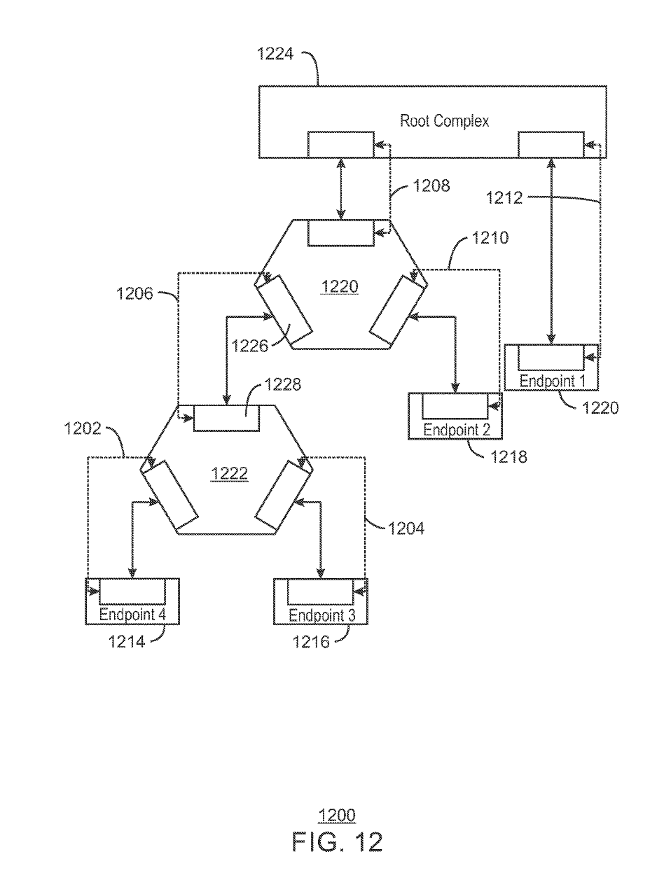

FIG. 12 is a diagram illustrating a cascaded switch hierarchy implemented with serial sideband links. Serial sideband links 1202, 1204, 1206, 1208, 1210, and 1212 are implemented between endpoints 1214, 1216, and 1218, as well as switches 1220 and 1222, and a root complex 1224 in a PCIe implementation.

During initial power on, a sideband link, such as any one of the serial sideband links 1202-1212, may be configured to initialize in a legacy mode where a signal lane from a downstream port and a signal lane from an upstream port are used propagate legacy PCIe packets. For example, a signal lane from a downstream port is used as PERST#, and the signal lane from an upstream port is used as CLKREQ#. A Basic Input Output System (BIOS) (not shown) or other software associated with the switch hierarchy illustrated in FIG. 12 may be configured to detect support for the serial sideband links 1202-1212 and enable them. The BIOS may be configured to detect the serial sideband link capability from a configuration bit for example. As a Link Training and Status State Machine (LTSSM) associated with the hierarchy goes to Detect, Disabled, L1, L2, or after power on reset the asynchronous handshake for the serial sideband link described above is performed. In some scenarios, profile negotiation is performed in Detect and after power on reset.

In the example illustration of FIG. 12, an asynchronous handshake between endpoint 1214 and switch 1222 triggers a handshake between an upstream port 1228 of switch 1222 and a downstream port 1226 of switch 1220. The handshake triggered between the switch 1220 and the switch 1222 may then trigger an asynchronous handshake between the switch 1220 and the root complex 1224 if information needs to be conveyed upstream. Latencies for transmitting OBFF messages may equal to the sum of latencies for each link.

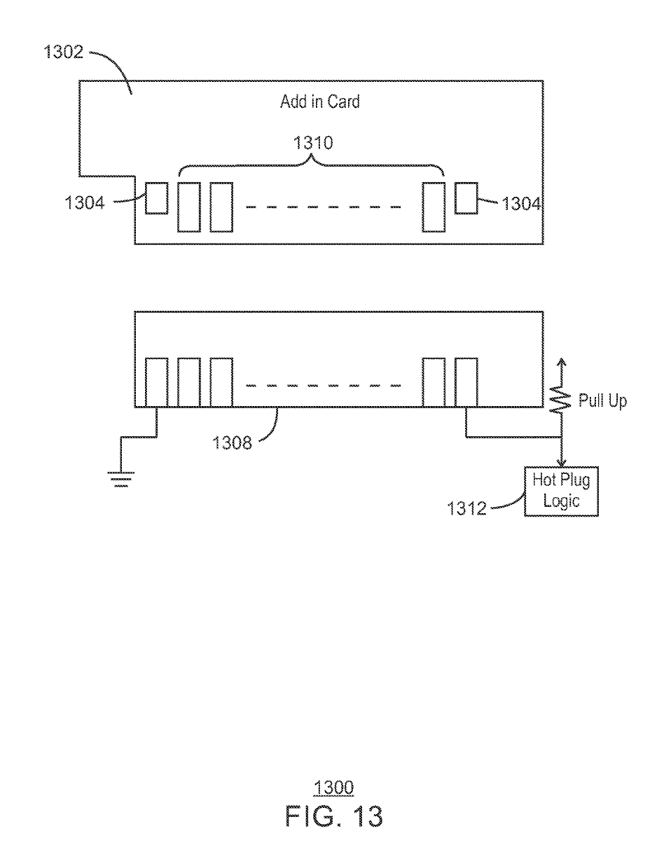

FIG. 13 is a diagram illustrating an add-in card (AIC) having pins for serial sideband signaling. An AIC 1302 may have physical pins 1304 and 1306 operable to propagate serial sideband signals. An add-in card, or AIC, as referred to herein, is an expansion component configured to add functionality to a computing system when received at a system board connector 1308. An asynchronous handshake, as discussed above, may indicate a presence of a logical entity like the AIC 1302 at the other end of a link.

In some cases, the AIC 1302 may be susceptible to hot plug and unplug events discussed above in regard to FIG. 4. In the embodiments described herein, the pins 1304 and 1306 may be shorter than main band signaling pins indicated at 1310. In this case, the pins 1304 and 1306 of the serial sideband signaling are the last to come into physical contact with pins of the system board connector 1308 when the AIC 1302 is physically plugged into the system board connector 1308. Further, when the AIC 1302 is physically removed the pins 1304 and 1306 associated with serial sideband signaling are the first to be removed from the pins of the system board connector 1308. This may be useful to hot plug and unplug logic 1312 of a computing system of which the system board connector 1308 is associated. Specifically, when the pins 1304 and 1306 are physically received at the system board connector 1308 in a hot plug event, the main band pins 1310 are more likely to have already been physically received at the system board connector 1308, and the main band signaling can commence. Likewise, during a hot unplug event, removal may preemptively indicate that a hot unplug event has occurred and main band signaling should cease.

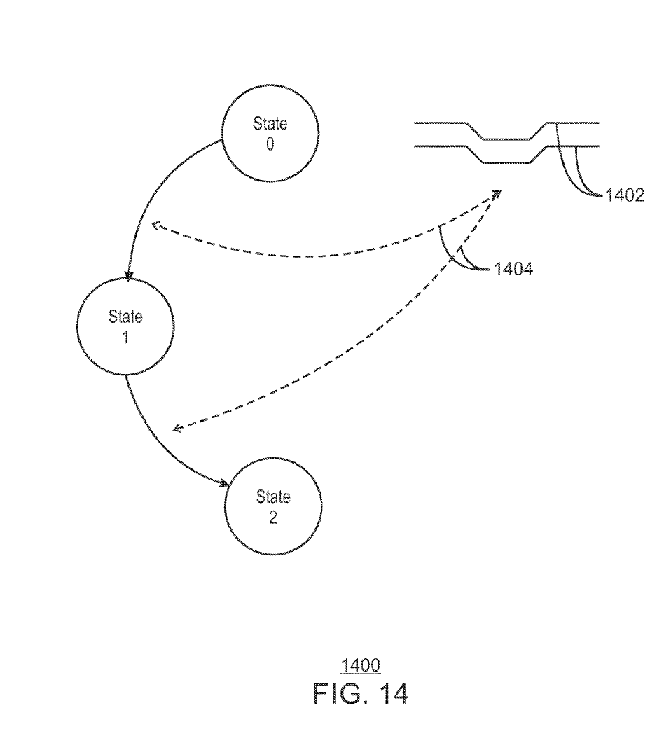

FIG. 14 is a diagram illustrating transitions of a Link Training and Status State Machine (LTSSM) indicated on the serial sideband link. As discussed above with regard to FIG. 12, state changes in the LTSSM may be communicated via transitions on the serial sideband link. Each time the LTSSM state changes, an asynchronous handshake may occur at the serial sideband link, as indicated at 1402 and 1404. This may enable deducing transitions into and out of low power states when PCIe retimers are not as robust.

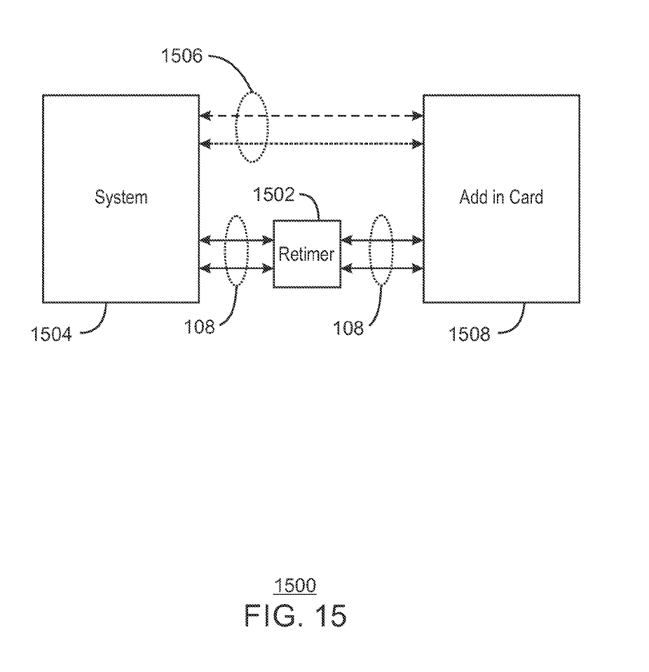

FIG. 15 is diagram illustrating a retimer within a serial sideband link that is configurable by the serial sideband link. A retimer 1502 may not be visible to software within a computing system 1504. In other words, software may only recognize a virtual link 1506 between the computing system 1504 and an AIC 1508 without the retimer 1502 in the middle. However, the retimer 1502 is visible to the serial sideband link 108, and therefore, may configure the retimer 1502.

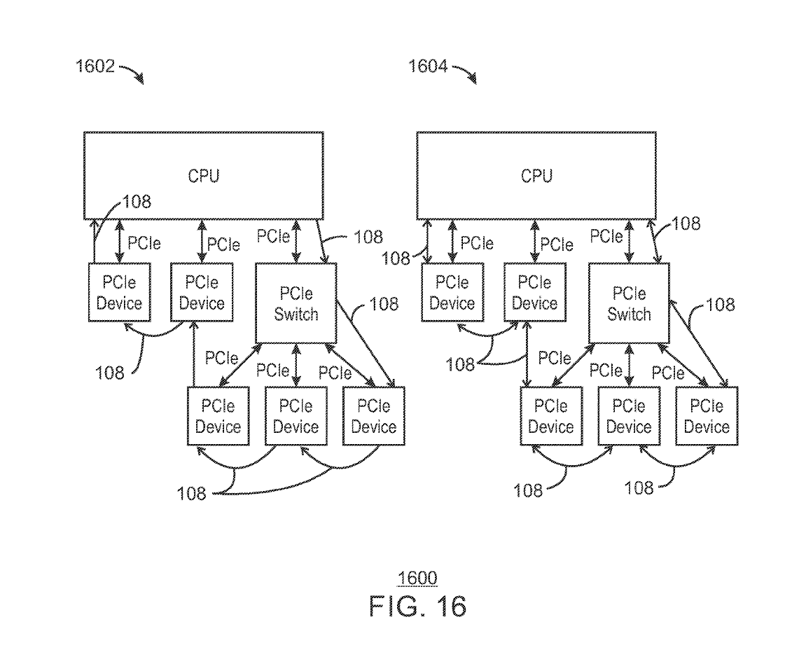

FIG. 16 are diagrams illustrating various ways in which the serial sideband signaling may be arranged in a daisy chain fashion. A daisy chain, as referred to herein is wiring scheme wherein multiple devices are wired together in sequence or in a ring. For example, at 1602, serial sideband links are configurable to be daisy chained in a unidirectional ring. At 1604, serial sideband links are configurable to be daisy chained in bidirectional ring. In this manner, the serial sideband link may be enumerated, and debug testability in complex system hierarchies may be enabled.

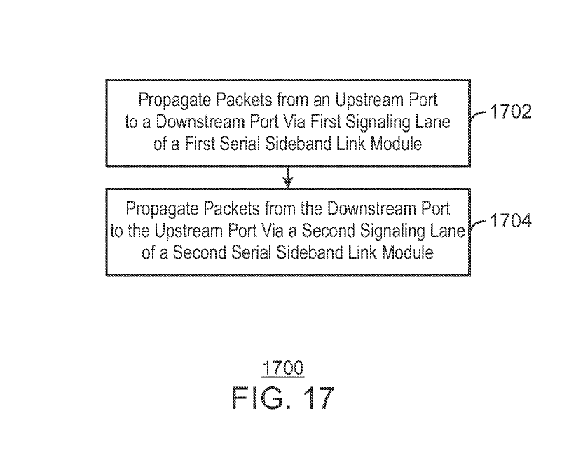

FIG. 17 is a block diagram illustrating a method of serial sideband link signaling. The method 1700 may include propagating, at block 1702, packets from an upstream port to a downstream port via first signaling lane of a first serial sideband link module. At block 1704, packets are propagated from the downstream port to the upstream port via a second signaling lane of a second serial sideband link module.

Other method steps are considered. For example, the method 1700 may include initiating an asynchronous handshake via the first serial sideband link module, the second sideband link module, or both sideband link modules to wake up a serial sideband link, and performing an asynchronous handshake each time a state change is indicated for a main signaling link with which the sideband signaling is associated. The method 1700 may also include encoding the packets propagate using pulse width modulation (PWM) without propagation of a separate clock signal. In some cases, the method 1700 includes interfacing the serial sideband link modules with one or more sideband link input/output (I/O) technologies.

Example 1 includes an apparatus for sideband signaling. The apparatus includes a first serial sideband link module to propagate packets from an upstream port to a downstream port via a first signaling lane. The apparatus also includes a second serial sideband link module to propagate packets from the downstream port to the upstream port via a second signaling lane.

Example 1 may incorporate additional subject matter. For example, an asynchronous handshake is initiated by the first serial sideband link module, the second sideband link module, or both sideband link modules to wake up a serial sideband link. As another example packets propagate using pulse width modulation (PWM) encoding without propagation of a separate clock signal. In general, the sideband signaling is asynchronous on the serial sideband link. The serial sideband link modules are configured to interface with one or more sideband link input/output (I/O) technologies. In some cases, the signaling lanes are connected to Universal Serial Bus (USB) future use pins. Further, the apparatus is connectable to one or more apparatuses for serial sideband signaling in a daisy chain configuration. An asynchronous handshake received at the second serial sideband link module indicates a presence of a logical entity at another port. The sideband link signaling may be communicated over a connector having pins associated with the sideband link that are shorter than other pins of the connector. The sideband link modules are to communicate state changes for a main signaling link with which the sideband signaling is associated by performing an asynchronous handshake each time a state change is indicated.

Example 2 includes a method for sideband signaling. The method includes propagating packets from an upstream port to a downstream port via first signaling lane of a first serial sideband link module. The method also includes propagating packets from the downstream port to the upstream port via a second signaling lane of a second serial sideband link module.

Example 2 may incorporate additional subject matter. For example, the method may include initiating an asynchronous handshake via the first serial sideband link module, the second sideband link module, or both sideband link modules to wake up a serial sideband link. The method may also include encoding the packets propagate using pulse width modulation (PWM) without propagation of a separate clock signal. The sideband signaling is asynchronous in general. The method may also include interfacing the serial sideband link modules with one or more sideband link input/output (I/O) technologies. In some cases, the signaling lanes are connected to Universal Serial Bus (USB) future use pins. The method may further include connecting each of the signaling lanes to one or more additional serial sideband signaling links in a daisy chain configuration. In some cases, the method may include receiving an asynchronous handshake at the second serial sideband link module indicating a presence of a logical entity at another port. Further, in some scenarios, the sideband link signaling is communicated over a connector comprising pins associated with the sideband link that are shorter than other pins of the connector. Further, the method may include performing an asynchronous handshake each time a state change is indicated for a main signaling link with which the sideband signaling is associated.

Example 3 describes a system for sideband signaling. The system includes a first signaling lane, a first serial sideband link module to propagate packets from an upstream port to a downstream port via the first signaling lane, a second signaling lane, and a second serial sideband link module to propagate packets from the downstream port to the upstream port via the second signaling lane.

Example 3 may incorporate additional subject matter similar to the subject matter of Example 1. For example, an asynchronous handshake is initiated by the first serial sideband link module, the second sideband link module, or both sideband link modules to wake up a serial sideband link. As another example packets propagate using pulse width modulation (PWM) encoding without propagation of a separate clock signal. In general, the sideband signaling is asynchronous on the serial sideband link. The serial sideband link modules are configured to interface with one or more sideband link input/output (I/O) technologies. In some cases, the signaling lanes are connected to Universal Serial Bus (USB) future use pins. Further, the system is connectable to one or more other systems for serial sideband signaling in a daisy chain configuration. An asynchronous handshake received at the second serial sideband link module indicates a presence of a logical entity at another port. The sideband link signaling may be communicated over a connector having pins associated with the sideband link that are shorter than other pins of the connector. The sideband link modules are to communicate state changes for a main signaling link with which the sideband signaling is associated by performing an asynchronous handshake each time a state change is indicated.

Example 4 includes an apparatus for sideband signaling. The apparatus includes a first means to propagate packets from an upstream port to a downstream port via a first signaling lane, and a second means to propagate packets from the downstream port to the upstream port via a second signaling lane.

In some cases, the first and second means include any type of logic, such as electrical circuits, configured to propagate packets in the manner described in Example 4. Other means may include computer-readable medium instructions, that when executed by a processing device may cause the apparatus to perform actions according to the method of Example 2.

Example 4 may incorporate additional subject matter similar to the subject matter of Example 1. For example, an asynchronous handshake is initiated by the first means, the second means, or both means to wake up a serial sideband link. As another example packets propagate using pulse width modulation (PWM) encoding without propagation of a separate clock signal. In general, the sideband signaling is asynchronous on the serial sideband link. The serial sideband link modules are configured to interface with one or more sideband link input/output (I/O) technologies. In some cases, the signaling lanes are connected to Universal Serial Bus (USB) future use pins. Further, the system is connectable to one or more other systems for serial sideband signaling in a daisy chain configuration. An asynchronous handshake received at the second means indicates a presence of a logical entity at another port. The sideband link signaling may be communicated over a connector having pins associated with the sideband link that are shorter than other pins of the connector. The first and second means are to communicate state changes for a main signaling link with which the sideband signaling is associated by performing an asynchronous handshake each time a state change is indicated.

Example 5 includes a sideband signaling link including a first serial sideband link module to propagate packets from an upstream port to a downstream port via a first signaling lane. The sideband signaling link also includes a second serial sideband link module to propagate packets from the downstream port to the upstream port via a second signaling lane.

Example 5 may incorporate additional subject matter. In some cases, Example 5 may incorporate the additional subject matter of Example 1.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

1-25. (canceled)

26. An apparatus for sideband signaling, comprising:
a first serial sideband link module to propagate packets from an upstream port to a downstream port via a first signaling lane;
a second serial sideband link module to propagate packets from the downstream port to the upstream port via a second signaling lane.

27. The apparatus for sideband signaling of claim 26, wherein an asynchronous handshake is initiated by the first serial sideband link module, the second sideband link module, or both sideband link modules to wake up a serial sideband link.

28. The apparatus for sideband signaling of claim 26, wherein the packets propagate using pulse width modulation (PWM) encoding without propagation of a separate clock signal.

29. The apparatus for sideband signaling of claim 26, wherein the sideband signaling is asynchronous.

30. The apparatus for sideband signaling of claim 26, wherein the serial sideband link modules are to interface with one or more sideband link input/output (I/O) technologies.

31. The apparatus for sideband signaling of claim 26, wherein the signaling lanes are connected to Universal Serial Bus (USB) future use pins.

32. The apparatus for sideband signaling of claim 26, wherein the apparatus is to connect to one or more apparatuses for sideband signaling in a daisy chain configuration.

33. The apparatus for sideband signaling of claim 26, wherein an asynchronous handshake received at the second serial sideband link module indicates a presence of a logical entity at another port.

34. The apparatus for sideband signaling of claim 26, wherein the sideband link signaling is communicated over a connector comprising pins associated with the sideband link that are shorter than other pins of the connector.

35. The apparatus for sideband signaling of claim 26, wherein the sideband link modules are to communicate state changes for a main signaling link with which the sideband signaling is associated by performing an asynchronous handshake each time a state change is indicated.

36. A method for sideband signaling, the method comprising:
propagating packets from an upstream port to a downstream port via first signaling lane of a first serial sideband link module;
propagating packets from the downstream port to the upstream port via a second signaling lane of a second serial sideband link module.

37. The method for sideband signaling of claim 36, comprising initiating an asynchronous handshake via the first serial sideband link module, the second sideband link module, or both sideband link modules to wake up a serial sideband link.

38. The method for sideband signaling of claim 36, comprising encoding the packets propagate using pulse width modulation (PWM) without propagation of a separate clock signal.

39. The method for sideband signaling of claim 36, wherein the sideband signaling is asynchronous.

40. The method for sideband signaling of claim 36, comprising interfacing the serial sideband link modules with one or more sideband link input/output (I/O) technologies.

41. The method for sideband signaling of claim 36, wherein the signaling lanes are connected to Universal Serial Bus (USB) future use pins.

42. The method for sideband signaling of claim 36, comprising connecting each of the signaling lanes to one or more additional sideband signaling in a daisy chain configuration.

43. The method for sideband signaling of claim 36, comprising receiving an asynchronous handshake at the second serial sideband link module indicating a presence of a logical entity at another port.

44. The method for sideband signaling of claim 36, wherein the sideband link signaling is communicated over a connector comprising pins associated with the sideband link that are shorter than other pins of the connector.

45. The method for sideband signaling of claim 36, comprising performing an asynchronous handshake each time a state change is indicated for a main signaling link with which the sideband signaling is associated.

46. A system for sideband signaling, the system comprising:
a first signaling lane;
a first serial sideband link module to propagate packets from an upstream port to a downstream port via the first signaling lane;
a second signaling lane; and
a second serial sideband link module to propagate packets from the downstream port to the upstream port via the second signaling lane.

47. The system for sideband signaling of claim 46, wherein:
the sideband signaling is asynchronous;
an asynchronous handshake is initiated by the first serial sideband link module, the second sideband link module, or both sideband link modules to wake up a serial sideband link; and
an asynchronous handshake received at the second serial sideband link module indicates a presence of a logical entity at another port.

48. The system for sideband signaling of claim 46, wherein the packets propagate using pulse width modulation (PWM) encoding without propagation of a separate clock signal.

49. The system for sideband signaling of claim 46, wherein the serial sideband link modules are to interface with one or more sideband link input/output (I/O) technologies.

50. The system for sideband signaling of claim 46, wherein the sideband link modules are to communicate state changes for a main signaling link with which the sideband signaling is associated by performing an asynchronous handshake each time a state change is indicated.
